(19) United States
(12) Patent Application Publication
(10) Pub. No.: US 2022/0301246 A1
(43) Pub. Date: Sep. 22, 2022

(54) STORE MANAGEMENT SYSTEM, STORE MANAGEMENT METHOD, COMPUTER PROGRAM AND RECORDING MEDIUM

(71) Applicant: NEC CORPORATION, Tokyo (JP)

(72) Inventor: Rina TOMITA, Tokyo (JP)

(73) Assignee: NEC CORPORATION, Tokyo (JP)

(21) Appl. No.: 17/638,574

(22) PCT Filed: Aug. 4, 2020
(86) PCT No.: PCT/JP2020/029845

§ 371 Date: Feb. 25, 2022

(30) Foreign Application Priority Data
Aug. 28, 2019 (JP) 2019-155549

(51) Int. Cl. G06T 11/60; G06T 7/00; G06Q 30/06; G06Q 10/06

(52) U.S. Cl. CPC G06T 11/60; G06T 7/0002; G06Q 30/06; G06Q 10/0631

(57) ABSTRACT

A store management system includes: a generation unit that generates an instruction image for conveying a work instruction by superimposing, on a captured image of a store, information about the work instruction related to a target in the captured image; and a transmission unit that transmits the instruction image to an operator to whom the work instruction is to be conveyed. This makes it possible to accurately convey the contents of a work instruction in a store. According to such a store management system, it is possible to accurately convey the contents of the work instruction in the store.

### TECHNICAL FIELD

The present invention relates to a store management system, a store management method, a computer program and a recording medium that manage a store.

### BACKGROUND ART

A known system of this type monitors a situation of a store. For example, Patent Literature 1 discloses a technique/technology of monitoring a display shelf on the basis of an image or video in which the display shelf in the store is recorded. Patent Literature 2 discloses a technique/technology of managing an article information and automatically instructing an operator to replenish merchandise.

As another related technique/technology, Patent Literature 3 discloses a technique/technology of composing or combining handwritten data with an image.

### CITATION LIST

### Patent Literature

Patent Literature 1: International Publication No. WO2016/084305 Pamphlet
Patent Literature 2: JP2010-186318A
Patent Literature 3: JP2014-149634A

### SUMMARY

### Technical Problem

When a store is managed, it is required to give an appropriate work instruction to the operator in accordance with a monitoring result. However, in Patent Literature 1 described above, only an alert notification is given when a store shelf is not detected at a predetermined position, and a specific work instruction method is not mentioned. Patent Literature 2 mentions only about transmitting an instruction information to a portable terminal, and there is room for improvement in terms of accurately conveying instruction contents to the operator.

In view of the problems described above, it is therefore an example object of the present invention to provide a store management system, a store management method, a computer program, and a recording medium that are configured to accurately convey the contents of a work instruction in a store.

### Solution to Problem

A store management system according to an example aspect of the present invention includes: a generation unit that generates an instruction image for conveying a work instruction by superimposing, on a captured image of a store, information about the work instruction related to a target in the captured image; and a transmission unit that transmits the instruction image to an operator to whom the work instruction is to be conveyed.

A store management method according to an example aspect of the present invention includes: a generation step that generates an instruction image for conveying a work instruction by superimposing, on a captured image of a store, information about the work instruction related to a target in the captured image; and a transmission step that transmits the instruction image to an operator to whom the work instruction is to be conveyed.

A computer program according to an example aspect of the present invention allows a computer to execute: a generation step that generates an instruction image for conveying a work instruction by superimposing, on a captured image of a store, information about the work instruction related to a target in the captured image; and a transmission step that transmits the instruction image to an operator to whom the work instruction is to be conveyed.

On a recording medium according to an example aspect of the present invention, the computer program described above is recorded.

### Advantageous Effects of Invention

According to the store management system, the store management method, the computer program, and the recording medium in the respective example aspects described above, it is possible to accurately convey the contents of a work instruction in a store by transmitting an instruction image on which information about the work instruction is superimposed,

### BRIEF DESCRIPTION OF DRAWINGS

FIG. 1 is a block diagram illustrating an overall configuration of a store management system according to an example embodiment.

FIG. 2 is a block diagram illustrating a hardware configuration of the store control apparatus according to the example embodiment.

FIG. 3 is a flowchart illustrating a flow of the operation of the store management system according to the example embodiment.

FIG. 4 is a diagram illustrating an example of an instruction image generated by a handwriting input.

FIG. 5 is a diagram illustrating an example of a transmission list displayed when an instruction image is transmitted.

FIG. 6 is a diagram illustrating an example of a notification on a terminal that has received the instruction image.

FIG. 7 is a diagram illustrating an example of a list of sharing members to whom the instruction image is transmitted.

FIG. 8 is a diagram illustrating an example of a confirmation button for conveying the confirmation of a work instruction.

FIG. 9 is a diagram illustrating an example of a reply image in which a reply message is added to the work instruction.

FIG. 10 is a diagram illustrating an example of a screen transition flow in an application of the store management system according to the example embodiment.

FIG. 11 is a diagram illustrating an example of a multiple display function in the application of the store management system according to the example embodiment.

FIG. 12 is a diagram illustrating an example of a store comparison function in the application of the store management system according to the example embodiment.

### DESCRIPTION OF EXAMPLE EMBODIMENTS

Hereinafter, a store management system, a store management method, a computer program, and a recording medium according to an example embodiment will be described with reference to the drawings.

(System Configuration)

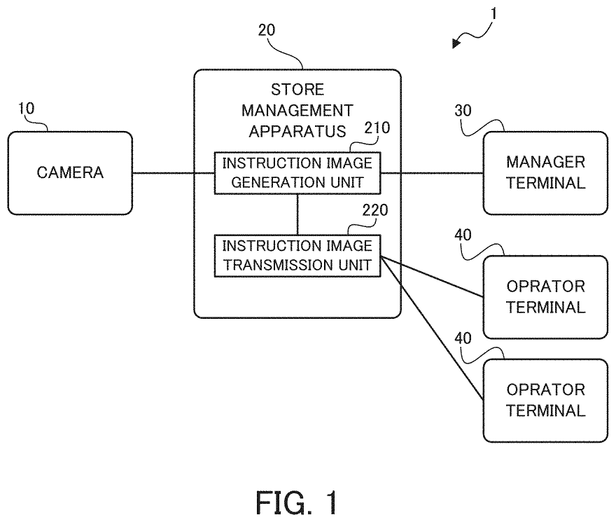

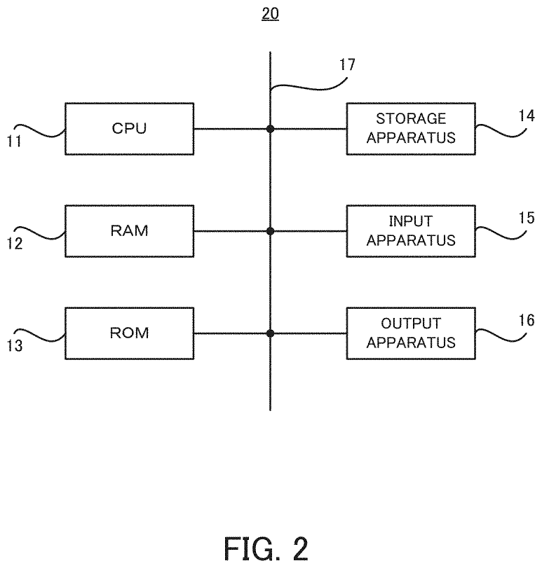

Firstly, a configuration of a store management system according to an example embodiment will be described with reference to FIG. 1 and FIG. 2. FIG. 1 is a block diagram illustrating an overall configuration of the store management system according to the example embodiment. FIG. 2 is a block diagram illustrating a hardware configuration of the store control apparatus according to the example embodiment.

In FIG. 1, a store management system 1 according to the example embodiment is a system applied to a store, such as, for example, a convenience store, and includes a camera 10, a store management apparatus 20, a manager terminal 30, and a plurality of operator terminals 40 as main components.

The camera 10 is configured to image the interior of the store or the periphery of the store. The camera 10 may be one that captures a moving image, or may be one that periodically captures a still image at a constant cycle. There may be a plurality of cameras 10 that are installed for one store. Incidentally, the camera 10 is preferably installed so as not to allow blind spots in the store. If a target monitored (in other words, a target managed) by the store management system 1 is limited, an imaging range may be limited. The captured image captured by the camera is configured to be outputted to the store managing apparatus 20.

The store management apparatus 20 is configured, for example, as a management server. The store management apparatus 20 may correspond to a plurality of cameras 10. Furthermore, the store management apparatus 20 may correspond to a plurality of stores (in other words, the cameras 10 installed in the respective stores). The store management apparatus includes an instruction image generation unit 210 and an instruction image transmission unit 220 as logical processing blocks for realizing the functions.

The instruction image generation unit 210 generates an instruction image for conveying a work instruction to an operator on the basis of the captured image captured by the camera 10, and information about the work instruction inputted from the manager terminal 30. Specifically, the instruction image generation unit 210 generates the instruction image by superimposing the information about the work instruction on the captured image. A specific example of the instruction image will be described in detail later. The instruction image generated by the instruction image generation unit 210 is configured to be outputted to the instruction image transmission unit 220.

The instruction image transmission unit 220 transmits the instruction image generated by the instruction image generation unit 210 to an operator to whom the work instruction is to be conveyed (specifically, an operator terminal 40 possessed by the operator). The instruction image transmission unit 220 is configured to select a terminal to which the instruction image is transmitted, among a plurality of operator terminals 40 and to transmit the instruction image to the terminal. A method of selecting the operator terminal 40 to which the instruction image is transmitted will be described in detail later.

As illustrated in FIG. 2, the store management apparatus 20 according to the example embodiment includes a CPU (Central Processing Unit) 11, a RAM (Random Access Memory) 12, a ROM (Read Only Memory) 13, and a storage apparatus 14. The store management apparatus 20 may further include an input apparatus 15 and an output apparatus 16. The CPU 11, the RAM 12, the ROM 13, the storage apparatus 14, the input apparatus 15, and the output apparatus 16 are connected through a data bus 17.

The CPU 11 reads a computer program. For example, the CPU 11 may read a computer program stored by at least one of RAM 12, ROM 13 and the storage apparatus 14. For example, the CPU 11 may read a computer program stored in a computer-readable recording medium, by using a not illustrated recording medium reading apparatus. The CPU 11 may obtain (i.e., read) a computer program from a not-illustrated apparatus located outside the store management apparatus 20, through a network interface. The CPU 11 controls the RAM 12, the storage apparatus 14, the input apparatus 15, and the output apparatus 16 by executing the read computer program. Especially in the example embodiment, when the CPU 11 executes the read computer program, a functional block for generating and transmitting the instruction image is implemented in the CPU 11. The instruction image generation unit 210 and the instruction image transmission unit 220 described above are implemented in this CPU 11, for example.

The RAM 12 temporarily stores the computer program to be executed by the CPU 11. The RAM 12 temporarily stores the data that is temporarily used by the CPU 11 when the CPU 11 executes the computer program. The RAM 12 may be, for example, a D-RAM (Dynamic RAM).

The ROM 13 stores the computer program to be executed by the CPU 11. The ROM 13 may otherwise store fixed data. The ROM 13 may be, for example, a P-ROM (Programmable ROM).

The storage apparatus 14 stores the data that is stored for a long term by the store management system 1. The storage apparatus 14 may operate as a temporary storage apparatus of the CPU 11. The storage apparatus 14 may include, for example, at least one of a hard disk apparatus, a magneto-optical disk apparatus, an SSD (Solid State Drive), and a disk array apparatus.

The input apparatus 15 is an apparatus that receives an input instruction from a user of the store management system 1. The input apparatus 15 may include, for example, at least one of a keyboard, a mouse, and a touch panel.

The output apparatus 16 is an apparatus that outputs information about the store management system 1 to the outside. For example, the output apparatus 16 may be a display apparatus that is configured to display the information about the store management system 1.

Returning to FIG. 1, the manager terminal 30 is a terminal possessed by a manager who manages the store (in other words, an instructor who issues the work instruction), and is configured, for example, as a personal computer, a tablet, or a smartphone. When there are a plurality of managers, a plurality of manager terminals 30 may be provided. The manager terminal 30 is configured to input the information about the work instruction in the store. The manager terminal 30 is configured to specify, for example, a target (a target position, a target object, or a target article of merchandise, etc.) of the work instruction in the captured image and to input the work contents. Incidentally, the manager terminal 30 may be a terminal that also functions as the operator terminal 40. In this case, the manager may be positioned or regarded as an operator.

The operator terminal 40 is a terminal possessed by an operator (e.g., a store staff, etc.) who performs a work in the store, and is configured, for example, as a personal computer, a tablet, or a smartphone possessed by each of a plurality of operators. The operator terminal 40 is configured to receive and display the instruction image. Incidentally, the operator terminal 40 may be a terminal that also functions as the manager terminal 30. In this case, the operator may be positioned or regarded as the manager.

(Explanation of Operation)

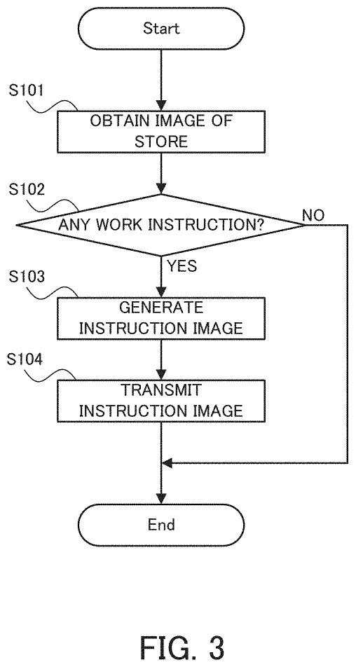

Next, a flow of the operation of the store management system 1 according to the example embodiment will be described with reference to FIG. 3. FIG. 3 is a flowchart illustrating the flow of the operation of the store management system according to the example embodiment.

As illustrated in FIG. 3, in operation of the store management system 1 according to the example embodiment, firstly, the camera 10 obtains an image of the store (step S101). The captured image obtained by the camera 10 is cut and treated for each area (e.g., for each shelf to display merchandise) in the store.

Subsequently, the instruction image generation unit 210 determines whether or not there is a work instruction corresponding to the obtained captured image (step S102). The instruction image generation unit 210 determines whether or not there is a work instruction, for example, depending on whether or not there is the information about the work instruction inputted by the manager terminal 30. That is, it is determined that there is a work instruction when the manager who sees the obtained captured image inputs the information about the work instruction, and it is determined that there is no work instruction when the manager who sees the obtained captured image does not input the information about the work instruction.

Alternatively, the instruction image generation unit 210 may determine whether or not there is a work instruction from a result of analysis of the captured image. Specifically, when an abnormality (e.g., out of stock, dirty, a suspicious person, etc.) in a store is automatically detected by the analysis of the captured image, the instruction image generation unit 210 may determine that there is a work instruction. Incidentally, a detailed description of the detection of abnormality using the captured image will be omitted because it is possible to appropriately adopt the existing techniques/technologies.

When it is determined that there is no work instruction (step S102: NO), the subsequent processing is omitted and a series of operation steps is ended. That is, the operation is ended without generating and transmitting the instruction image. In this case, the processing may be restarted from the step S101 after a lapse of a predetermined period.

On the other hand, when it is determined that there is a work instruction (step S102: YES), the instruction image generation unit 210 superimposes the information about the work instruction on the captured image and generates an instruction image (step S103). Then, the instruction image transmission unit 220 transmits the generated instruction image to the operator terminal 40 (step S104).

(Specific Example of Instruction Image)

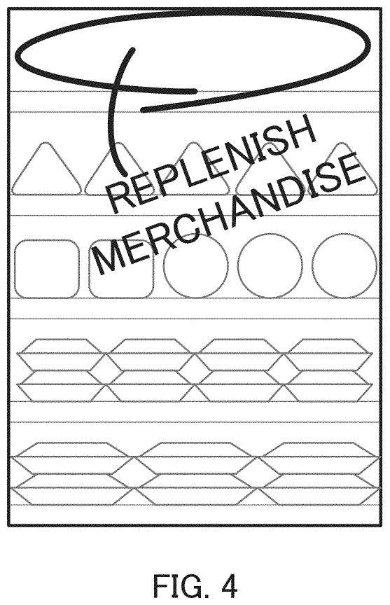

Next, with reference to FIG. 4, an example of a specific instruction image will be described. FIG. 4 is a diagram illustrating an example of an instruction image generated by a handwriting input. In the following, an explanation will be given to a case where an image of a merchandise display shelf (e.g., a shelf where onigiri or rice balls and lunch boxes are displayed) at a convenience store is obtained as the captured image.

As illustrated in FIG. 4, the instruction image is generated as an image obtained by superimposing the information about the work instruction on the captured image. In the example in FIG. 4, information indicating a target position of the work instruction (i.e., a part surrounded by a circle in FIG. 4) and information indicating the work contents (i.e., a word “REPLENISH MERCHANDISE” in FIG. 4) are superimposed on the image of the merchandise display shelf. In other words, the work instruction here is to “replenish a top shelf (i.e. a shelf that is currently empty) in the captured image with merchandise.”

Incidentally, the information about the work instruction may be inputted by handwriting as illustrated in FIG. 4. In this case, handwritten words and figures are superimposed directly on the captured image. Alternatively, the information about the work instruction may be inputted in a manner other than by handwriting. For example, the words indicating the work contents may be inputted by text by a keyboard or the like, or may be inputted by selecting a fixed phrase, a predetermined icon, or the like. Furthermore, when a specific area or object in the captured image is tapped, the tapped object may be automatically area-selected as the target of the work instruction.

(Transmission List)

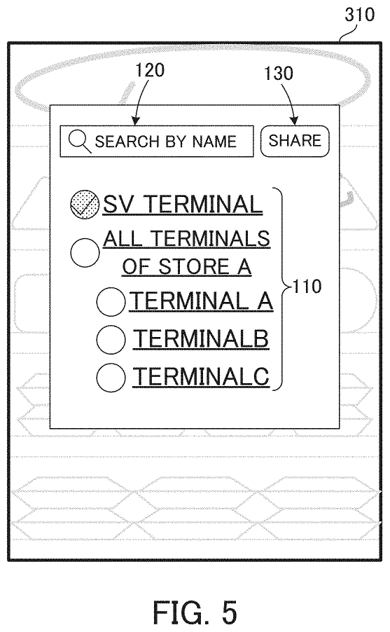

Next, with reference to FIG. 5, an explanation will be given to a transmission list used when the instruction image is transmitted. FIG. 5 is a diagram illustrating an example of the transmission list displayed when the instruction image is transmitted.

As illustrated in FIG. 5, when the generated instruction image is transmitted, a transmission list 110 may be displayed on the manager terminal 30 (i.e., the terminal of the manager that issues the work instruction). More specifically, a diagram as illustrated in FIG. 5 may be displayed on a display provided in the manager terminal 30. In the example illustrated in FIG. 5, a SV (supervisor) terminal, all terminals of a store A, each terminal of the store A (a terminal A, a terminal B, and a terminal C) are displayed as a sender. It is also possible to search a search box 120 for the terminals that are not included in the transmission list 120 and add it to the transmission list.

The manager selects (or checks) a terminal to which the work instruction should be transmitted (in other words, an operator to whom the work instruction should be transmitted) from the above-described transmission list, and taps a share button 130. Then, it is possible to transmit the instruction image only to the selected terminal.

It should be noted that only the terminals of the operators who can handle the work instructions may be displayed on the transmission list. For example, the operator terminal 40 possessed by the store staff who is in service is displayed on the transmission list, whereas the operator terminal 40 possessed by the store staff who is not in service may not be displayed on the transmission list.

(Example of Notification to Operator)

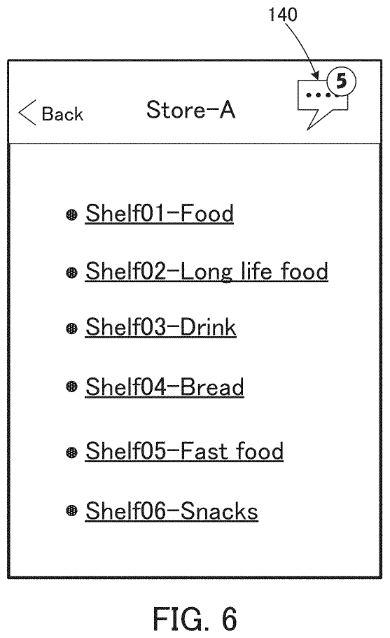

Next, with reference to FIG. 6, an explanation will be given to an example of notification to the operator when the instruction image is received. FIG. 6 is a diagram illustrating an example of notification on the terminal that has received the instruction image.

As illustrated in FIG. 6, a notification icon 140 (see upper right in FIG. 6) is displayed on the operator terminal 40 that has received the instruction image. By this notification icon being displayed, the operator can know that the work instruction is given from the manager. The operator can view the received instruction image by tapping the notification icon 140 on the operator terminal 40. Incidentally, the notification icon 140 may display a number indicating the number of notification (“5” in the example in FIG. 6).

(Sharing Member List)

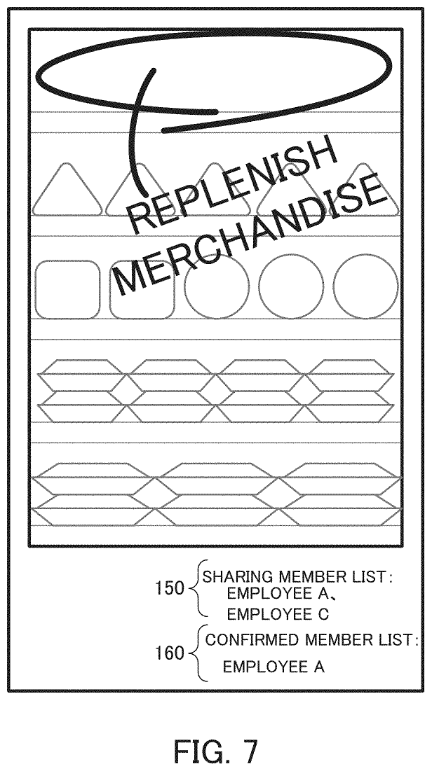

Next, a sharing member list for the instruction image will be described with reference to FIG. 7. FIG. 7 is a diagram illustrating an example of the list of sharing members to whom the instruction image is transmitted.

As illustrated in FIG. 7, a sharing member list 150 may be displayed on the transmitted instruction image. The sharing member list 150 displays in a list format a member with whom the instruction image is shared (i.e., a holder of the terminal to which the instruction image is transmitted). By confirming the sharing member list 150, the manager or the operator can confirm to whom the instruction images is transmitted (in other words, to whom the work instruction is given). In the example in FIG. 7, an employee A and an employee C are displayed as the sharing members.

A confirmed member list 160 may be displayed on the transmitted instruction image. The confirmed member list 160 displays in a list format a member who has confirmed the instruction image (i.e., a member who has actually viewed the instruction image from among holders of the terminals to which the instruction image is transmitted). By confirming the confirmed member list 160, the manager or the operator can confirm whether the instruction image is confirmed (in other words, whether the work instruction is conveyed). In the example in FIG. 7, only the employee A is displayed as a confirmed member from among the employee A and the employee C, who are the sharing members. Regarding the confirmation of the instruction image may be set when the instruction image is viewed, or may be set when the operator performs various operations or the like described later.

(Example of Operation by Operator)

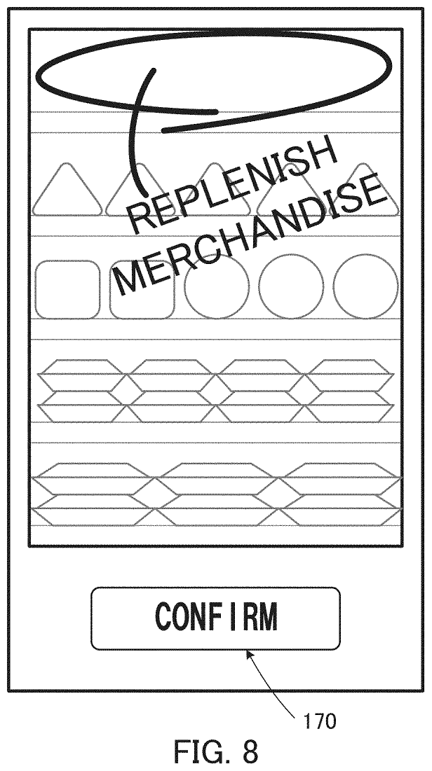

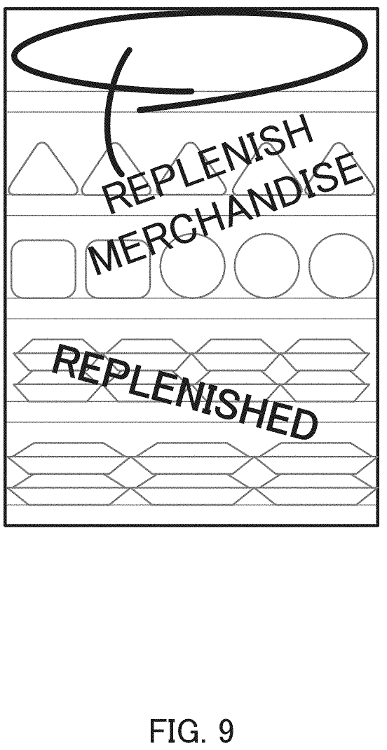

Next, with reference to FIG. 8 and FIG. 9, the operation performed by the operator who has received the instruction image will be described. FIG. 8 is a diagram illustrating an example of a confirmation button for conveying the confirmation of a work instruction. FIG. 9 is a diagram illustrating an example of a reply image in which a reply message is added to the work instruction.

As illustrated in FIG. 8, a confirmation button 170 may be displayed on the instruction image. The confirmation button is a button for the operator who has received the instruction image to inform the others whether or not the operator has confirmed the instruction image. The operator who has received the instruction image taps the confirmation button, for example, when confirming (in other words, viewing) the instruction image or when completing the work contents indicated by the instruction image. Then, the confirmation of the instruction image by the operator is conveyed to the manager who has transmitted the instruction image or other operator (e.g., the operator who has tapped the confirmation button is added to the confirmed member list 160 illustrated in FIG. 7). Thus, the use of the confirmation button 170 makes it possible to grasp whether the operator has confirmed the instruction image (in other words, whether or not it is a situation in which the instruction image is transmitted, but the work instruction is not conveyed).

As illustrated in FIG. 9, the operator who has received the instruction image can add new additional information (e.g., reply message, etc.) to the instruction image and transmit the image to the manager or other operators. In this way, information can be exchanged by utilizing the instruction image. Specifically, as in the example illustrated in FIG. 9, by adding and transmitting a word “REPLENISHED”, it is possible to inform the manager or other operators that a work related to the work instruction is completed.

In addition, when multiple users superimpose information on the image as illustrated in FIG. 9, a display aspect of the information may be changed for each user. For example, if the color of words is changed for each user, it is possible to easily distinguish who has written even when the words inputted by multiple users are superimposed.

### Technical Effects

Next, technical effects obtained by obtained by the store management system 1 according to the example embodiment will be described.

As described in FIG. 1 to FIG. 9, according to the store management system 1 in the example embodiment, it is possible to accurately convey the work instruction by transmitting the instruction image to the operator. The work instruction may be conveyed simply with text data, but the text data alone may not allow the operator to accurately understand the work contents. In the example embodiment, however, the work contents are transmitted by the instruction image obtained by superimposing the information about the work instruction (especially, information about the work instruction related to the target in the captured image) on the captured image of the store. For this reason, the operator who has received the instruction image can easily understand a position and an object that are the targets of the work instruction, and the work contents, or the like.

<Example of Application of Store Management System>

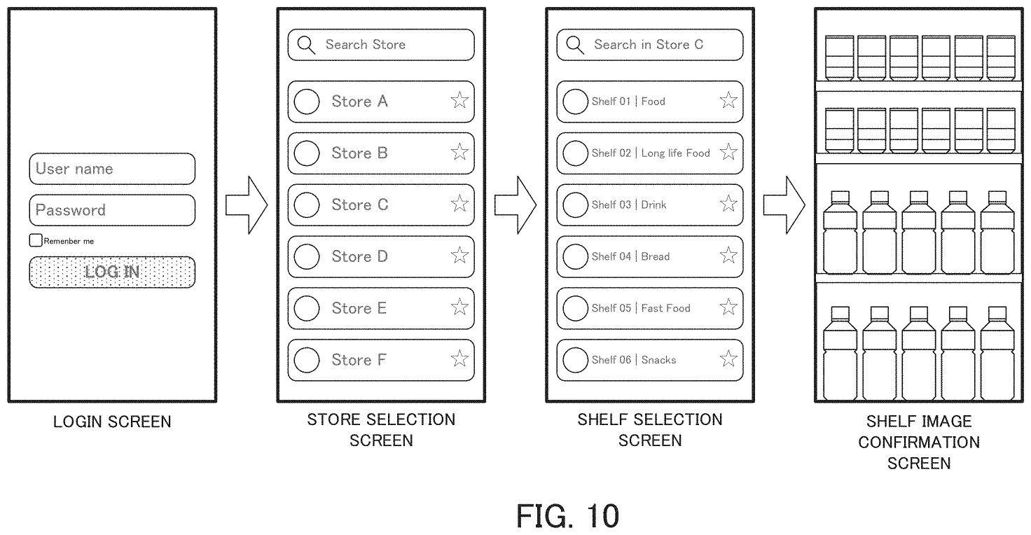

Next, a specific example of an application (e.g., a smartphone application) used when using the store management system 1 according to the example embodiment will be described with reference to FIG. 10 to FIG. 12. It is assumed that such an application is preinstalled, for example, in the manager terminal 30 and the operator terminal 40 described above, or the like.

(Application Screen Transition Flow)

Firstly, a screen transition flow in an application will be described with reference to FIG. 10. FIG. 10 is a diagram illustrating an example of the screen transition flow in the application of the store management system according to the example embodiment.

As illustrated in FIG. 10, the manager or the operator who intends to use the store management system 1 inputs a preset “user name” and “password” on a login screen to log into the application. Then, a store selection screen including a plurality of store items (here, Store A to Store F) in alignment is displayed on a display of the terminal. Subsequently, when a store is selected (here, a Store C is selected) on the store selection screen, a shelf selection screen including a plurality of shelf items (here, Shelf 01 to Shelf 06) in alignment is displayed. When a shelf is selected (here, Shelf 03 is selected) on the shelf selection screen, an image of the selected shelf is displayed.

As described above, when using the store management system 1, it is possible to display the shelf image by subsequently selecting the “store” and the “shelf” after logging into the application. However, when the store management system 1 is used for only one store, the store selection screen may be omitted and the shelf selection screen may be displayed immediately after login. In the case of the present example embodiment, the instruction image with the work instruction superimposed thereon may be displayed as the shelf image.

(Multiple Display Function)

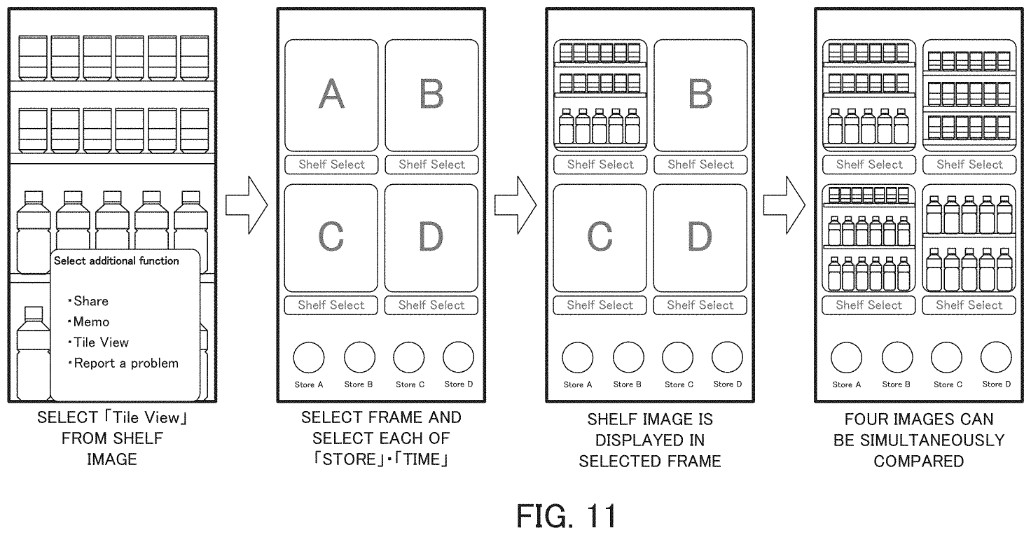

Next, a function of displaying a plurality of images in the application will be described with reference to FIG. 11. FIG. 11 is a diagram illustrating an example of a multiple display function in the application of the store management system according to the example embodiment. As illustrated in FIG. 11, when the “Tile View” is selected from a function panel while the shelf image is displayed, the multiple display function for displaying a plurality of shelf images at the same time can be used. Specifically, when “Tile View” is selected, a plurality of display frames (here, 4 frames of A to D) are displayed on the screen. After selecting one of the frames and selecting “store” and “time”, the shelf image in the selected time zone of the selected shop can be displayed in the selected frame. By selecting “store” and “time” for all the frames in this way, in the end, it is possible to display four shelf images at the same time. This makes it possible to confirm a plurality of shelf images at the same time. Here, simultaneous display in 4 frames of 2×2 is exemplified, but the shelf images may be simultaneously displayed in different layouts.

By displaying a plurality of shelf images at the same time, for example, it is possible to compare the states of shelves between one store and another store. Thus, it is possible to confirm, for example, a difference in merchandise arrangement with that of an excellent store. In the case of the example embodiment, the instruction image with the work instruction superimposed thereon may be displayed as the plurality of shelf images displayed at the same time.

(Store Comparison Function)

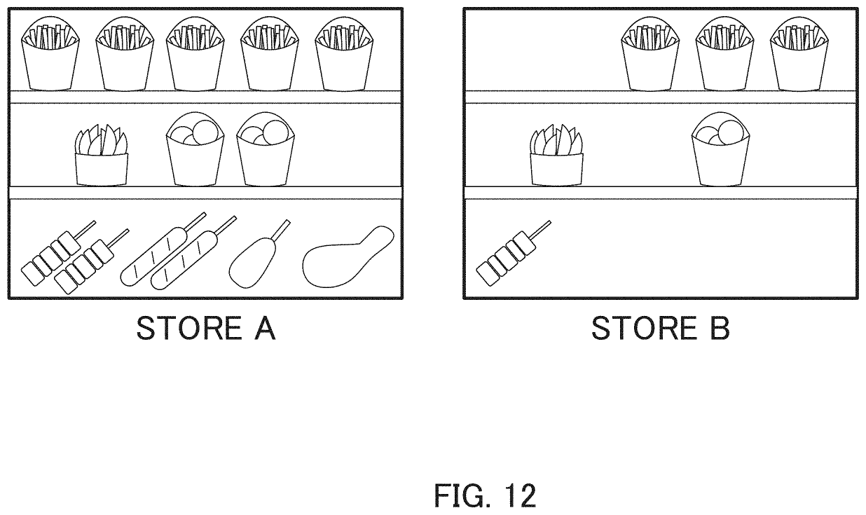

Next, a store comparison function in the application will be described with reference to FIG. 12. FIG. 12 is a diagram illustrating an example of the store comparison function in the application of the store management system according to the example embodiment.

As illustrated in FIG. 12, a function of confirming a difference in merchandise display between stores by displaying the shelf images of two different stores side by side may be provided. For example, by displaying the shelves of Store A and Store B side by side, as illustrated in FIG. 12, it is possible to check the merchandise that is short of stock or the merchandise that is sold out. Thus, by arranging the images side by side to allow them to be compared, it is possible to convey the information that is difficult to convey by email, telephone, or the like, in an easy-to-understand manner. In the case of the example embodiment, the instruction image with the work instruction superimposed thereon may be displayed as the shelf image that is displayed side by side.

<Supplementary Notes>

With respect to the example embodiment described above, the following Supplementary Notes will be further disclosed.

(Supplementary Note 1)

A store management system described in Supplementary Note 1 is A store management system including: a generation unit that generates an instruction image for conveying a work instruction by superimposing, on a captured image of a store, information about the work instruction related to a target in the captured image; and a transmission unit that transmits the instruction image to an operator to whom the work instruction is to be conveyed.

(Supplementary Note 2)

A store management system described in Supplementary Note 2 is the store management system described in Supplementary Note 1, wherein the captured image is an image of a merchandise display shelf in the store.

(Supplementary Note 3)

A store management system described in Supplementary Note 3 is the store management system described in Supplementary Note 1 or 2, wherein the generation unit receives an input of the information about the work instruction by an instructor, and generates the instruction image on the basis of the captured image and the input from an input unit.

(Supplementary Note 4)

A store management system described in Supplementary Note 4 is the store management system described in Supplementary Note 3, wherein the input unit allows a hand-writing input, and the generation unit generates the instruction image by superimposing handwritten contents on the captured image.

(Supplementary Note 5)

A store management system described in Supplementary Note 5 is the store management system described in any one of Supplementary Notes 1 to 4, wherein the generation unit detects an abnormality in the captured image and generates the instruction image by superimposing information about a work instruction related to the abnormality.

(Supplementary Note 6)

A store management system described in Supplementary Note 6 is the store management system described in any one of Supplementary Notes 1 to 5, further including a display unit that displays a list of the operators who can handle the work instruction, wherein the transmission unit transmits the instruction image to an operator selected from the list.

(Supplementary Note 7)

A store management system described in Supplementary Note 7 is the store management system described in any one of Supplementary Notes 1 to 6, further including an operator terminal possessed by the operator, wherein the operator terminal adds another information that is different from the information about the work instruction, to the instruction image that is transmitted to the operator by the transmission unit.

(Supplementary Note 8)

A store management system described in Supplementary Note 8 is the store management system described in Supplementary Note 7, wherein the operator terminal adds a confirmed information indicating that the operator has confirmed the work instruction, as the another information.

(Supplementary Note 9)

A store management method described in Supplementary Note 9 is a store management method including: a generation step that generates an instruction image for conveying a work instruction by superimposing, on a captured image of a store, information about the work instruction related to a target in the captured image; and a transmission step that transmits the instruction image to an operator to whom the work instruction is to be conveyed.

(Supplementary Note 10)

A computer program described in Supplementary Note 10 is a computer program that allows a computer to execute: a generation step that generates an instruction image for conveying a work instruction by superimposing, on a captured image of a store, information about the work instruction related to a target in the captured image; and a transmission step that transmits the instruction image to an operator to whom the work instruction is to be conveyed.

(Supplementary Note 11)

A recording medium described in Supplementary Note 11 is a recording medium on which the computer program described in Supplementary Note 10 is recorded.

The present invention is not limited to the examples described above and is allowed to be changed, if desired, without departing from the essence or spirit of the invention which can be read from the claims and the entire specification. A store management system, a store management method, a computer program and a recording medium with such changes are also intended to be within the technical scope of the present invention.

To the extent permitted by law, this application is based upon and claims the benefit of priority from Japanese Patent Application No. 2019-155549, filed Aug. 28, 2019, and incorporates all of its disclosure herein. Also, to the extent permitted by law, all the publications and articles described in the description are incorporated herein by reference.

### DESCRIPTION OF REFERENCE CODES

1 Store management system
10 Camera
20 Store management apparatus
30 Manager terminal
40 Operator terminal
110 Transmission list
140 Notification icon
150 Sharing member list
160 Confirmed member list
170 Confirmation button
210 Instruction image generation unit
220 Instruction image transmission unit

1. A store management system comprising:
at least one memory that is configured to store informations; and
at least one processor that is configured to execute instructions
to generate an instruction image for conveying a work instruction by superimposing, on a captured image of a store, information about the work instruction related to a target in the captured image; and
to transmit the instruction image to an operator to whom the work instruction is to be conveyed.

2. The store management system according to claim 1, wherein the captured image is an image of a merchandise display shelf in the store.

3. The store management system according to claim 1, wherein the processor receives an input of the information about the work instruction by an instructor, and generates the instruction image on the basis of the captured image and the input of the information about the work instruction.

4. The store management system according to claim 3, wherein
the information about the work instruction allows a hand-writing input, and
the processor generates the instruction image by superimposing handwritten contents on the captured image.

5. The store management system according to claim 1, wherein the processor detects an abnormality in the captured image and generates the instruction image by superimposing information about a work instruction related to the abnormality.

6. The store management system according to claim 1, wherein the processor
displays a list of the operators who can handle the work instruction, and
transmits the instruction image to an operator selected from the list.

7. The store management system according to claim 1, further comprising an operator terminal possessed by the operator, wherein
the operator terminal adds another information that is different from the information about the work instruction, to the instruction image that is transmitted to the operator by the processor.

8. The store management system according to claim 7, wherein the operator terminal adds a confirmed information indicating that the operator has confirmed the work instruction, as the another information.

9. A store management method comprising:
generating an instruction image for conveying a work instruction by superimposing, on a captured image of a store, information about the work instruction related to a target in the captured image; and
transmitting the instruction image to an operator to whom the work instruction is to be conveyed.

10. A non-transitory recording medium on which a computer program that allows a computer to execute a store management method,
the store management method including:
generating an instruction image for conveying a work instruction by superimposing, on a captured image of a store, information about the work instruction related to a target in the captured image; and
transmitting the instruction image to an operator to whom the work instruction is to be conveyed.

11. (canceled)
